(19) United States
(12) Patent Application Publication
(10) Pub. No.: US 2017/0018285 A1
(43) Pub. Date: Jan. 19, 2017

(54) BARIUM HEXA-FERRITE TECHNOLOGY FOR MAMR AND ADVANCED MAGNETIC RECORDING APPLICATIONS

(71) Applicant: HGST Netherlands B.V., Amsterdam (NL)

(72) Inventors: Zhaohui CHEN, San Jose, CA (US); Fan YANG, San Jose, CA (US)

(73) Assignee: HGST Netherlands B.V.

(21) Appl. No.: 14/799,313

(22) Filed: Jul. 14, 2015

(51) Int. Cl. G11B 5/65; G11B 5/84; G11B 5/66

(52) U.S. Cl. CPC G11B 5/653; G11B 5/66; G11B 5/84; G11B 2005/0024

(57) ABSTRACT

Embodiments disclosed herein generally relate to a magnetic recording medium for MAMR. The magnetic disk device may comprise a substrate and a magnetic layer, the magnetic layer comprising barium-based hexa-ferrite. The magnetic recording medium may also optionally include a soft underlayer, a seed layer, and/or an overcoat.

### BACKGROUND

Field

Embodiments disclosed herein generally relate to a magnetic disk employing barium hexa-ferrite technology and methods for production.

Description of the Related Art

Recent advances demand dramatic increases in the storage capacity of magnetic disk drives. Such storage capacity is generally governed by areal density (AD), a measure of the number of bits that may be stored in a given area. At the same time, a good signal-to-noise ratio (SNR) promotes efficient and accurate storage and retrieval of information in the magnetic disk drive. Further, improved data stability increases the lifetime of the magnetic disk drive. Areal density, signal to noise ratio, and data stability are significantly affected by the recording media, the read head and the write head.

Microwave-assisted magnetic recording (MAMR) is a method that enables improvements in both AD and SNR. In MAMR, a spin torque oscillator is provided near the write head to provide a microwave magnetic field. The microwave magnetic field serves to reduce the coercivity of the recording media.

To further improve AD and SNR, MAMR may be deployed in bit patterned media (BPM) format. In a magnetic disk that employs a MAMR head, the magnetic layer typically comprises a metal-containing material such as a metal alloy or metal multilayer. Patterning such a metal-containing magnetic layer is difficult and may result in degraded magnetic properties or other damage to the device. A metal-containing magnetic layer in nano-sized bit array naturally exhibits reduced stability and sensitivity to oxidation during processing, including bit-patterning. To prevent such damage, areal density and signal-to-noise ratio may be sacrificed.

Therefore, there is a need in the art for an improved magnetic disk that employs a MAMR head.

### SUMMARY

Embodiments disclosed herein generally relate to a magnetic disk device for MAMR. The magnetic disk device may comprise a substrate and a magnetic layer, the magnetic layer comprising barium-based hexa-ferrite. The magnetic disk device may also optionally include a soft underlayer, a seed layer, and/or an overcoat.

One embodiment may comprise a magnetic recording medium, comprising a substrate and an underlayer, and a magnetic layer, wherein the magnetic layer comprises barium-based hexaferrite.

Another embodiment may comprise a microwave-assisted magnetic recording disk drive, comprising a magnetic head assembly and a magnetic recording medium for microwave-assisted magnetic recording. The magnetic recording medium may comprise a substrate, an underlayer, and a magnetic layer. The magnetic layer may comprise barium-based hexa-ferrite.

Another embodiment may comprise a method for fabricating a microwave-assisted magnetic recording medium, comprising depositing an underlayer over a substrate; depositing a magnetic layer over the underlayer, wherein the magnetic layer comprises barium-based hexa-ferrite; and patterning the magnetic layer.

### BRIEF DESCRIPTION OF THE DRAWINGS

So that the manner in which the above recited features of the disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments in any field involving magnetic sensors.

FIG. 1 illustrates a disk drive system, according to embodiments described herein.

FIG. 2 is a cross sectional view of a MAMR head and magnetic disk of the disk drive system of FIG. 1, according to embodiments described herein.

FIG. 3 is a cross sectional view of a magnetic disk device, according to embodiments described herein.

FIG. 4 illustrates a method for fabricating a MAMR storage medium.

FIG. 5A is a top view of a magnetic recording medium according to one embodiment.

FIG. 5B is a cross sectional view of a magnetic recording medium according to one embodiment.

FIG. 6A is a top view of a magnetic recording medium according to one embodiment.

FIG. 6B is a cross sectional view of a magnetic recording medium according to one embodiment.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

In the following, reference is made to embodiments. However, it should be understood that the disclosure is not limited to specific described embodiments. Instead, any combination of the following features and elements, whether related to different embodiments or not, is contemplated to implement and practice the claimed subject matter. Furthermore, although embodiments described herein may achieve advantages over other possible solutions and/or over the prior art, whether or not a particular advantage is achieved by a given embodiment is not limiting of the claimed subject matter. Thus, the following aspects, features, embodiments and advantages are merely illustrative and are not considered elements or limitations of the appended claims except where explicitly recited in a claim(s).

Embodiments disclosed herein generally relate to a magnetic recording medium for MAMR. The magnetic recording medium may comprise a substrate and a magnetic layer, the magnetic layer comprising barium-based hexa-ferrite. The magnetic recording medium may also optionally include a soft underlayer, a seed layer, and/or an overcoat.

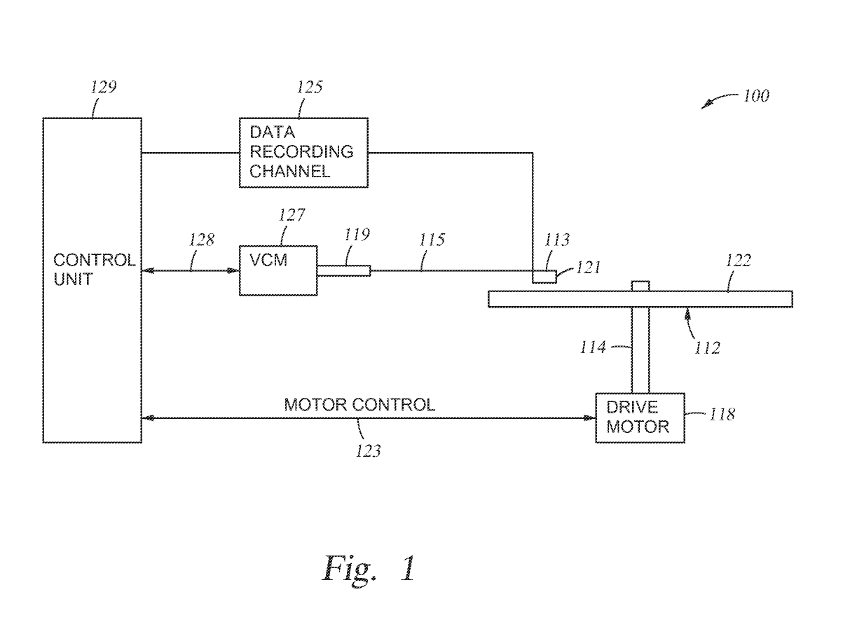

FIG. 1 illustrates a disk drive 100 according to embodiments described herein. As shown, at least one rotatable magnetic media, such as a magnetic disk 112, is supported on a spindle 114 and rotated by a disk drive motor 118. The magnetic recording on each disk may be in the form of annular patterns of concentric data tracks (not shown) on the magnetic disk 112.

At least one slider 113 is positioned near the magnetic disk 112, each slider 113 supporting one or more magnetic head assemblies 121 that may include an STO for applying an AC magnetic field to the disk surface 122. As the magnetic disk rotates, the slider 113 moves radially in and out over the disk surface 122 so that the magnetic head assembly 121 may access different tracks of the magnetic disk 112 where desired data are written. Each slider 113 is attached to an actuator arm 119 by way of a suspension 115. The suspension 115 provides a slight spring force which biases the slider 113 toward the disk surface 122. Each actuator arm 119 is attached to an actuator means 127. The actuator means 127 as shown in FIG. 1 may be a voice coil motor (VCM). The VCM comprises a coil movable within a fixed magnetic field, the direction and speed of the coil movements being controlled by the motor current signals supplied by control unit 129.

During operation of the MAMR enabled disk drive 100, the rotation of the magnetic disk 112 generates an air bearing between the slider 113 and the disk surface 122 which exerts an upward force or lift on the slider 113. The air bearing thus counter-balances the slight spring force of suspension 115 and supports slider 113 off and slightly above the disk 112 surface by a small, substantially constant spacing during normal operation. The AC magnetic field generated from the magnetic head assembly 121 lowers the effective coercivity of the media during writing so that the write elements of the magnetic head assemblies 121 may correctly magnetize the data bits in the media.

The various components of the disk drive 100 are controlled in operation by control signals generated by control unit 129, such as access control signals and internal clock signals. Typically, the control unit 129 comprises logic control circuits, storage means and a microprocessor. The control unit 129 generates control signals to control various system operations such as drive motor control signals on line 123 and head position and seek control signals on line 128. The control signals on line 128 provide the desired current profiles to optimally move and position slider 113 to the desired data track on disk 112. Write and read signals are communicated to and from write and read heads on the assembly 121 by way of recording channel 125.

The above description of a typical magnetic disk storage system and the accompanying illustration of FIG. 1 are for representation purposes only. It should be apparent that disk storage systems may contain a large number of disks and actuators, and each actuator may support a number of sliders.

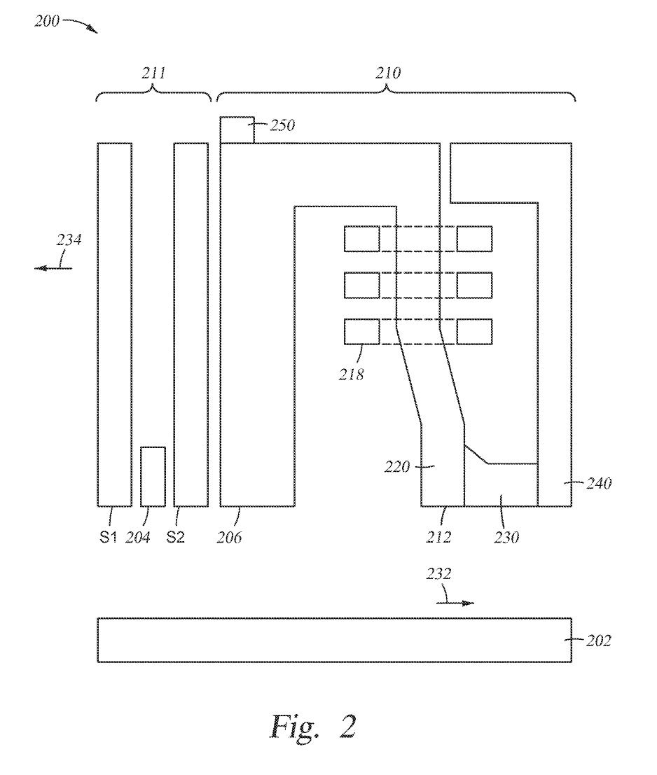

FIG. 2 is a fragmented, cross sectional side view through the center of a MAMR read/write head 200 facing a magnetic recording medium 202. The read/write head 200 and magnetic recording medium 202 may correspond to the magnetic head assembly 121 and magnetic recording medium 112, respectively in FIG. 1. The read/write head 200 includes a media facing surface (MFS) 212, such as an ABS, a magnetic write head 210 and a magnetic read head 211, and is mounted such that the MFS 212 is facing the magnetic recording medium 202. In FIG. 2, the disk 202 moves past the write head 210 in the direction indicated by the arrow 232 and the read/write head 200 moves in the direction indicated by the arrow 234.

In some embodiments, the magnetic read head 211 is a magnetoresistive (MR) read head that includes an MR sensing element 204 located between MR shields S1 and S2. In other embodiments, the magnetic read head 211 is a magnetic tunnel junction (MTJ) read head that includes a MTJ sensing device 204 located between MR shields S1 and S2. The magnetic fields of the adjacent magnetized regions in the magnetic recording medium 202 are detectable by the MR (or MTJ) sensing element 204 as the recorded bits.

The write head 210 includes a return pole 206, a main pole 220, a trailing shield 240, a STO 230 disposed between the main pole 220 and the trailing shield 240, and a coil 218 that excites the main pole 220. A recording magnetic field is generated from the main pole 220 and the trailing shield 240 helps make the magnetic field gradient of the main pole 220 steep. The main pole 220 may be a magnetic material such as a CoFe alloy. In one embodiment, the main pole 220 has a saturated magnetization (Ms) of 2.4 T and a thickness of about 300 nanometers (nm). The trailing shield 240 may be a magnetic material such as NiFe alloy. In one embodiment, the trailing shield 240 has a Ms of about 1.2 T.

The main pole 220, the trailing shield 240 and the STO 230 all extend to the MFS 212, and the STO 230 disposed between the main pole 220 and the trailing shield 240 is electrically coupled to the main pole 220 and the trailing shield 240. The STO 230 may be surrounded by an insulating material (not shown) in a cross-track direction (into and out of the paper). During operation, a current is applied to the STO 230 to generate an AC magnetic field that travels to the magnetic recording medium 202 to lower the coercivity of the region of the magnetic recording medium 202 adjacent to the STO 230. The direction of the current applied to the STO 230 may be reversed during operation in order to optimize the frequencies of the STO 230. The current flowed to the STO 230 at a first direction may be referred to as applying a positive polarity bias to the STO 230, and the current flowed to the STO 230 at a second direction which is the reverse direction of the first direction may be referred to as applying a negative polarity bias to the STO 230. The STO 230 can oscillate at both positive and negative polarities and achieve different frequencies. The write head 210 further includes a heater 250 for adjusting the distance between the read/write head 200 and the magnetic recording medium 112. The location of the heater 250 is not limited to above the return pole 206, as shown in FIG. 2. The heater 250 may be disposed at any suitable location.

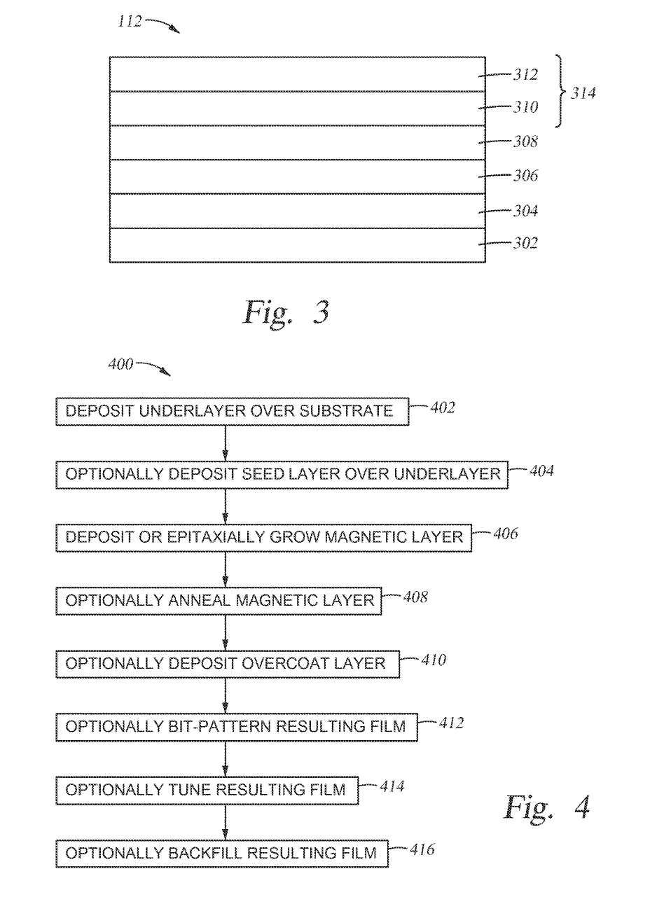

FIG. 3 is a cross sectional view of a magnetic recording medium 112. The magnetic recording medium 112 may comprise a substrate 302. Over the substrate may be deposited a soft underlayer 304. The underlayer 304 may comprise an anti-ferromagnetically coupled multi-layer structure that includes at least two layers of a soft magnetic alloy having a film thickness of between about 10 nm and about 30 nm, such as about 20 nm, and a non-magnetic material layer, such as Ru, inserted between the layers of the soft magnetic alloy, having a film thickness between about 0.1 nm and about 2 nm, such as about 0.5 nm, in various embodiments. The soft magnetic alloy may comprise Fe, Co, Ta, and/or Zr, such as Fe_{w}CoₓTa_{y}Zr_{z} in one embodiment. The soft magnetic underlayer 304 has the effects of forming a magnetic path for the recording magnetic field and improving recording characteristics of the magnetic head in general. Furthermore, noise may be suppressed by using an anti-ferromagnetic coupling arrangement. A seed layer 306 may be disposed over the underlayer 304. The seed layer may comprise magnesium oxide (MgO), aluminum oxide (Al₂O₃), gadolinium gallium garnet (GGG), ruthenium (Ru), platinum (Pt), ruthenium oxide (RuO₂), or another appropriate material. A magnetic layer 308 is provided over the seed layer 306 or, in the event no seed layer 306 is provided, a magnetic layer 308 is provided directly over the underlayer 304. An overcoat 314 may be provided over the magnetic layer 308. The overcoat may comprise two sublayers 310, 312. In one embodiment, the sublayer 310 that is disposed on the magnetic layer 308 may comprise carbon. In another embodiment, sublayer 310 may comprise carbon-based hard coatings such as diamond-like-carbon (DLC), AlTiC, etc. The second sublayer 312, which is disposed on the first sublayer 310, may comprise a lubrication layer 312. The lubrication layer 312 may comprise molybdenum (Mo) or another appropriate lubricant.

In conventional applications, the magnetic layer 308 is typically a metal-containing layer such as a metal alloy. In embodiments of the disclosure, the magnetic layer 308 comprises barium-based hexa-ferrite. In one embodiment, the barium hexa-ferrite may comprise M-type BaFe₁₂O₉. In another embodiment, other types of barium-based hexa-ferrite with a preferred C-axis orientation may be used. Barium-based hexa-ferrite has a high uniaxial magnetic anisotropy (Kᵤ), which allows for a smaller bit size, promoting increased density and increased memory lifetime.

FIG. 4 illustrates a method 400 for fabricating a MAMR storage medium. At 402, the underlayer 304 is deposited on the substrate. At 404, a seed layer 306 is optionally deposited over the underlayer 304. At 406, a magnetic layer such as a barium-based hexa-ferrite 308 layer may be deposited or epitaxially grown on the surface of the substrate 302, the underlayer 304 or the seed layer 306. The magnetic layer, which may be a barium-based hexa-ferrite layer 308 may be deposited using pulsed laser deposition, reactive sputtering, molecular beam epitaxy or any other suitable technique. At 408, the magnetic layer layer may optionally be annealed to enhance film properties and/or fine-tune the film's magnetic properties.

At 410, an overcoat layer 314 may optionally be deposited. If the magnetic layer 308 comprises barium-based hexa-ferrite, the overcoat layer 314 may be simplified, thinned or omitted entirely. In one embodiment, the carbon layer 310 may be omitted completely. In another embodiment, the lubrication layer 312 may be thinned or simplified. The barium-based hexa-ferrite layer 308 offers enhanced stability over metal-containing materials. For example, the barium-based hexa-ferrite layer 308 is mechanically tougher than metal-containing materials. Barium-based hexa-ferrite is also more chemically inert than metal-containing magnetic materials. Simplification, thinning or omission of the overcoat layer 314 narrows the spacing between the magnetic layer 308 and the write head 210. Reduction of the magnetic spacing between the magnetic layer 308 and the write head 210 promotes stability, improved AD and higher SNR. The high Ku of barium-based hexa-ferrite also leads to a longer lifetime for magnetic recording, up to or beyond ten years.

In one embodiment, the barium-based hexa-ferrite magnetic layer 308 is a continuous film blanked deposited on the seed layer 306. Using MAMR alone with a continuous film of barium-based hexa-ferrite may result in AD within or beyond the 1-1.5 Tb/in² range.

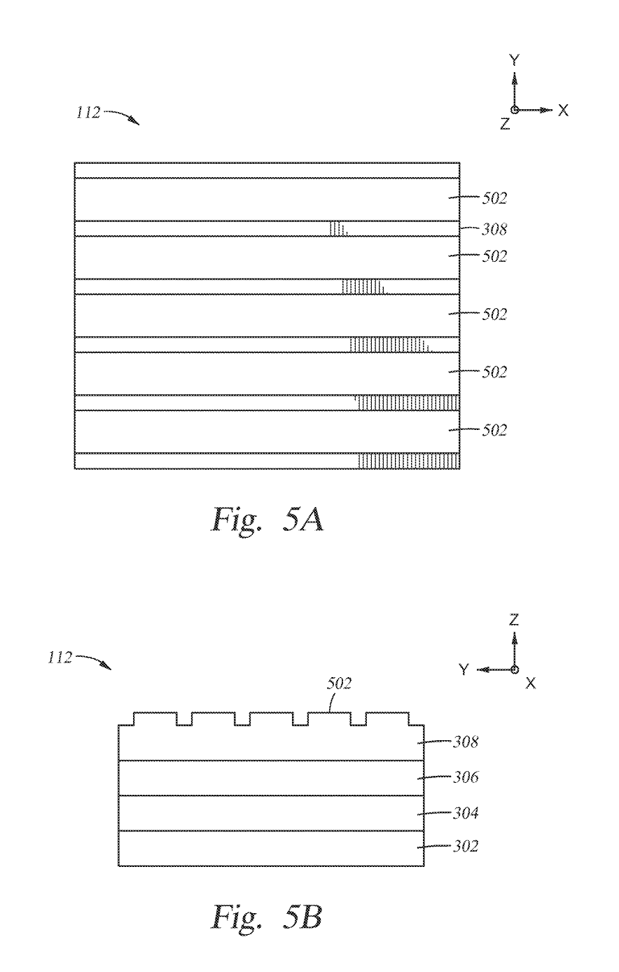

In another embodiment, as shown in FIG. 5A, the barium-based hexa-ferrite magnetic layer 308 is configured in a linear array deposited on the seed layer 306. FIG. 5A is a top view of a magnetic recording medium 112 comprising one embodiment of this linear array. FIG. 5B is a cross-sectional view of a magnetic recording medium 112 comprising an embodiment of the linear or trench array. As in FIG. 3, an underlayer 304 may be deposited over a substrate 302. A seed layer 306, as described above, may be deposited over the underlayer 304. A magnetic layer 308 is deposited over the seed layer 306 or the underlayer 304. In one embodiment the magnetic layer 308 comprises barium-based hexa-ferrite, as described above. Patterning results in the formation of an array of trenches or lines 502 in the magnetic layer 308. A person of ordinary skill in the art will appreciate that this is a close view of a detail of a magnetic recording medium 112 and that in full view the magnetic recording medium 112 may be circular in shape and the trenches or lines of magnetic material 502 may be circular in shape. The trench array allows for higher areal density than a continuous film because it allows increase in SNR and track pitch per inch (TPI) over continuous film.

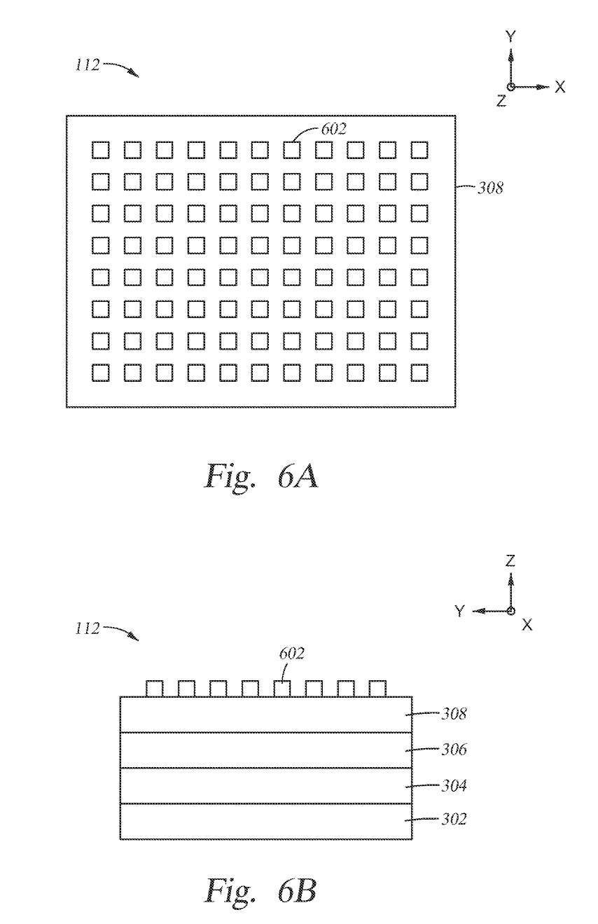

As an alternative to the trench or linear array shown in FIGS. 5A and 5B, at block 412 of FIG. 4, the barium-based hexa-ferrite layer 308 may be bit-patterned to further improve AD and SNR. FIG. 6A is a top view of a magnetic recording medium 112 comprising a bit-patterned barium-based hexa-ferrite layer 308 according to one embodiment. FIG. 6B is a cross sectional view of a magnetic recording medium 112 including a bit-patterned barium-based hexa-ferrite layer according to one embodiment. As in FIG. 3, an underlayer 304 may be deposited over a substrate 302. A seed layer 306, as described above, may be deposited over the underlayer 304. A magnetic layer 308 is deposited over the seed layer 306 or the underlayer 304. In one embodiment the magnetic layer 308 comprises barium-based hexa-ferrite, as described above. Bit-patterning results in the formation of bits 602 in the barium-based hexa-ferrite magnetic layer 308.

Conventional metal-containing magnetic layers used with MAMR typically result in AD of about 1 Tb/in². Using MAMR with bit-patterned media to pattern the barium-based hexa-ferrite film into an island array results in even greater improvements in areal density, up to or beyond 2.5 Tb/in². Such patterning may be achieved using nano-imprinting or nanolithography followed by reactive ion etching. Lithography of barium-based hexa-ferrite may achieve element density of 2f× 2f. The resulting well-defined nano-scale bit array provides enhanced magnetic recording technology. Use of MAMR combined with bit patterning allows for flexibility in the design of the island array and bit array. Such flexibility promotes enhanced areal density and performance. In the conventional metal-containing magnetic layer, bit patterning is much more difficult. In particular, nano-scale patterning is much more difficult to achieve and may involve a higher likelihood of damage to the magnetic layer because of the high energy of ions involved during (ion mill) processing. A metal-containing surface is unstable and chemically active and has a tendency to oxidize during processing. Oxidation of the metal-containing surface results in loss of magnetic properties. However, by using barium-based hexa-ferrite as the magnetic layer 308, the nano-scale patterning is easily achievable, and higher areal density is achieved.

Like the continuous film of barium-based hexa-ferrite, the bit-patterned barium-based hexa-ferrite array is stable. Such stability allows omission or simplification of the overcoat layer 314 to protect and passivate the top surface and side walls. This is true even of nano-scale patterning. As a result, the carbon layer 310 may be thinned or omitted entirely. The lubrication layer 312 may be thinned or simplified. Use of barium-based hexa-ferrite allows fine-tuning of the coercivity (H_{c}) of the island array, which allows for flexibility in media design. For example, the H_{c} of the island array may be fine-tuned to greater than about 4.5 kOe or another appropriate value. Fine-tuning of coercivity can be achieved by varying the deposition conditions, varying the design of island array, and/or by selecting particular seed layer.

At 414, shown in FIG. 4, the resulting film may be tuned with elements such as Sc, In, Al, Ga, or other suitable materials. Use of barium-based hexa-ferrite as the magnetic layer 308 allows fine-tuning of the uniaxial magnetic anisotropy (Kᵤ) of the island array to a value greater than, for example, 12 kOe. Use of barium-based hexa-ferrite as the magnetic layer 308 may also allow fine-tuning of the ferromagnetic resonance (FMR) of the island array to match the focused microwave source. More efficient coupling with the focused microwave source enables reduced current from the STO with little to no interference with the writing element. The FMR can be varied by varying the particular composition of the barium-based hexa-ferrite layer 308 and/or by designing the island array structure. Matching the FMR allows for better coupling with the write head 210. The FMR of a film that comprises a metal-containing magnetic layer is fixed and much more difficult to vary than that of a film comprising a barium-based hexa-ferrite magnetic layer.

At 416, it may be possible to backfill the spacing in either the trench array or the island array embodiment. Any appropriate material may be used for the backfilling step. Backfilling the spacing will stabilize the head movement by limiting the pressure differences as the head moves over the surface of the film.

As discussed above, use of a barium-based hexa-ferrite magnetic layer in a MAMR magnetic recording device offers many advantages. An overcoat layer may be simplified or omitted altogether because of the mechanical toughness and chemical inertness of barium-based hexa-ferrite. Therefore, use of barium-based hexa-ferrite film may reduce magnetic spacing and increase areal density. The barium-based hexa-ferrite film may be used as a continuous film or as a patterned nano-structure to further improve AD and other performance metrics. Selection of seed layers and doping elements, adjustment of deposition conditions, and variation in design of the island array allow fine-tuning of the bit-patterned island array.

While the foregoing is directed to embodiments of the disclosure, other and further embodiments may be devised without departing from the basic scope thereof, and the scope thereof is determined by the claims that follow.

1. A magnetic recording medium, comprising:
a substrate;
an underlayer; and
a magnetic layer, wherein the magnetic layer comprises barium-based hexa-ferrite.

2. The magnetic recording medium of claim 1, further comprising:
a seed layer disposed over the underlayer and under the magnetic layer.

3. The magnetic recording medium of claim 1, wherein the magnetic layer comprises M-type BaFe₁₂O₉ with a C-axis orientation.

4. The magnetic recording medium of claim 1, wherein a top surface of the disk comprises the magnetic layer.

5. The magnetic recording medium of claim 1, wherein the magnetic layer further comprises a material selected from the group consisting of Sc, In, Al, Ga.

6. The magnetic recording medium of claim 1, wherein the magnetic layer is bit-patterned to yield an island array.

7. The magnetic recording medium of claim 6, wherein the coercivity of the island array is greater than 4.5 kOe.

8. The magnetic recording medium of claim 6, wherein:
the magnetic layer further comprises with a material selected from the following group consisting of Sc, In, Al, Ga; and
uniaxial magnetic anisotropy of the island array is greater than 12 kOe.

9. A microwave-assisted magnetic recording disk drive, comprising:
a magnetic head assembly; and
a magnetic recording medium for microwave-assisted magnetic recording, comprising:
a substrate;
an underlayer; and
a magnetic layer, wherein the magnetic layer comprises barium-based hexa-ferrite.

10. The microwave-assisted magnetic recording disk drive of claim 9, further comprising:
a seed layer disposed over the underlayer and under the magnetic layer.

11. The microwave-assisted magnetic recording disk drive of claim 9, wherein the magnetic layer comprises M-type BaFe₁₂O₉ with a C-axis orientation.

12. The microwave-assisted magnetic recording disk drive of claim 9, wherein a top surface of the disk comprises the magnetic layer.

13. The microwave-assisted magnetic recording disk drive of claim 9, wherein the magnetic layer further comprises a material selected from the group consisting of Sc, In, Al, Ga.

14. The microwave-assisted magnetic recording disk drive of claim 9, wherein the magnetic layer is bit-patterned to yield an island array.

15. The microwave-assisted magnetic recording disk drive of claim 14, wherein the coercivity of the island array is greater than 4.5 kOe.

16. The microwave-assisted magnetic recording disk drive of claim 14, wherein:
the magnetic layer further comprises a material selected from the following group: Sc, In, Al, Ga; and
uniaxial magnetic anisotropy of the island array is greater than 12 kOe.

17. The microwave-assisted magnetic recording disk drive of claim 9, wherein the magnetic layer is patterned to yield a trench array.

18. A method for fabricating a microwave-assisted magnetic recording medium, comprising:
depositing an underlayer over a substrate;
depositing a magnetic layer over the underlayer, wherein the magnetic layer comprises barium-based hexa-ferrite; and
patterning the magnetic layer.

19. The method of claim 18, wherein the magnetic layer further comprises a material selected from the following group: Sc, In, Al, Ga.

20. The method of claim 17, further comprising:
annealing the magnetic layer.
